(19) United States
(12) Patent Application Publication
(10) Pub. No.: US 2023/0279174 A1
(43) Pub. Date: Sep. 7, 2023

(54) Multilayered Structure and a Process for Preparing the Same

(71) Applicant: BASF SE, Ludwigshafen am Rhein (DE)

(72) Inventors: Brad J. MARTIN, Wyandotte, MI (US); Gregory W. CARROLL, Wyandotte, MI (US)

(21) Appl. No.: 18/006,407

(22) PCT Filed: Jul. 23, 2021
(86) PCT No.: PCT/EP2021/070762

§ 371 Date: Jan. 23, 2023

Related U.S. Application Data
(60) Provisional application No. 63/056,052, filed on Jul. 24, 2020.

(30) Foreign Application Priority Data
Oct. 6, 2020 (EP) 20200418.0

(51) Int. Cl. C08G 18/66; C09D 175/08; C08G 18/10; C08G 18/20; C08G 18/76; A63B 41/02; B32B 3/04; B32B 27/40; B32B 27/08; B32B 7/02

(52) U.S. Cl. CPC C08G 18/6674; C09D 175/08; C08G 18/10; C08G 18/20; C08G 18/7664; C08G 18/7671; A63B 41/02; B32B 3/04; B32B 27/40; B32B 27/08; B32B 7/02; A63B 2209/00; B32B 2250/24; B32B 2307/536; B32B 2307/7376; B32B 2307/7242; B32B 2307/7244; B32B 2439/46

(57) ABSTRACT

Disclosed herein is a multi-layered structure and a process for preparing the same. Also disclosed herein is a pressurized bladder and a sports ball.

### FIELD OF INVENTION

The present invention relates to a multi-layered structured and a process for preparing the same. In particular, the present invention relates to a pressurized bladder for use in a sports ball.

### BACKGROUND OF THE INVENTION

Thermoplastic and thermoset polymeric materials have been widely used in membranes for their fluid (gas or liquid) barrier properties. Such fluid barrier films are used, for example, for plastic wrap materials and for other packaging materials. Another common application for polymeric materials with good fluid barrier properties is in the construction of inflatable bladders.

Inflatable bladders have been used in a wide variety of products such as vehicle tyres, balls, accumulators used on heavy machinery, and in footwear, especially shoes, as cushioning devices. Particularly for a sports ball application, the inflatable bladder or pressurized bladder is required to have a variety of characteristics, of which low air permeability is a must to have. Hence, it is important to choose a suitable elastomeric material, which has a considerably low air permeability with acceptable mechanical properties.

For example, U.S. Pat. No. 6,082,025 relates to membrane and membrane materials that offer enhanced flexibility and resistance to undesirable transmission of fluids such as an inflationary gas. Described here is an elastic membrane for inflatable bladders that can be inflated with a gas transmission rate of about 10 cm³/m²·atm·day or less.

Elastomeric materials having desired gas permeation levels, for example, described in U.S. Pat. No. 6,013,340 are in the form of flexible membranes comprising of polyurethane including a polyester polyol, said membrane having a gas transmission rate of 15 or less for nitrogen gas.

Another widely employed elastomeric material, particularly for use in sports ball, is rubber. Of the many kinds of rubber, bromobutyl rubber is an important material for pressurize bladders or air bladders in sports ball. Bromobutyl rubber is an elastomeric isobutylene-isoprene copolymer containing reactive bromine. Structurally, it is similar to chlorobutyl rubber and has good physical strength, vibration damping, low glass transition temperature, low permeability, and resistance to aging and weathering from atmospheric exposure. Particularly, because of its low gas permeability, bromobutyl rubber can maintain air pressure for a longer period than any other materials. Further, the softness, rubberiness and low modulus of the bromobutyl make it ideal for sports ball that require bounce.

In general, the state-of-the-art sports ball are manufactured via a multistep, labour intensive process. This includes winding the air bladder with high tensile modulus filament to minimize creep or dimensional change while in pressurized state. It is desirable to simplify and automate the existing production process and in doing so, polyurethane (PU) materials are very helpful. However, owing to certain restrictions in these materials when used as pressurized bladders, for example flexible PU elastomers are known to have relatively higher gas permeation rates than bromobutyl rubber and high creep rates, there is a need to provide a pressurized bladder which can overcome these challenges and outperform the conventional ones.

It was, therefore, an object of the present invention to provide a multilayer structure having improved barrier performance, such as but not limited to, gas permeability, tensile modulus and creep, and yet flexible enough when shaped as a pressurized bladder for use in a sports ball. It was another object of the present invention to provide a simplified and considerably less labour-intensive process for preparing a shaped article comprising the multilayer structure.

### SUMMARY OF THE INVENTION

Surprisingly, it has been found that the above-identified object is met by providing a multilayer structure, as described herein. Accordingly, in one aspect, the presently claimed invention is directed to a multilayer structure comprising:
(A) a first layer made of a first polyurethane material having a Shore A hardness of less than 80 determined according to ASTM D 2240 and obtained by reacting a first isocyanate component with a first polyol component, said first polyol component comprising a first polyether polyol having a nominal functionality of at least 2.0 and OH value ranging between 20 mg KOH/g to 100 mg KOH/g, and
(B) a second layer made of a second polyurethane material having a Shore D hardness of at least 40 determined according to ASTM D 2240 and obtained by reacting a second isocyanate component with a second polyol component, said second polyol component comprising at least one polyol having a nominal functionality of at least 2.0 and OH value ranging between 20 mg KOH/g to 1000 mg KOH/g.

In another aspect, the presently claimed invention is directed to the use of the multilayer structure for a pressurized bladder.

In still another aspect, the presently claimed invention is directed to a pressurized bladder comprising the above multilayer structure and having a nitrogen gas transmission rate of less than 70 cm³m⁻²day⁻¹bar⁻¹.

In yet another aspect, the presently claimed invention is directed to a process for preparing the above pressurized bladder, said process comprising
(BL1) molding the first polyurethane material in a mold to obtain the first layer,
(BL2) injecting the second polyurethane material in the mold of step (BL1) to encapsulate the first layer, at least partially with the second layer,
(BL3) shaping the first layer and the second layer of step (BL2) in the mold to obtain the pressurized bladder.

In a further aspect, the presently claimed invention is directed to a shaped article comprising the above multilayer structure.

In another aspect, the presently claimed invention is directed to a process for preparing the above shaped article, said process comprising at least:
(S1) molding the first polyurethane material in a mold to obtain the first layer,
(S2) injecting the second polyurethane material in the mold of step (S1) to obtain the second layer at least partially encapsulated by the first layer, and
(S3) shaping the first layer and the second layer of step (S2) in the mold to obtain the shaped article.

In yet another aspect, the presently claimed invention is directed to a sports ball comprising a bladder for enclosing a pressurized fluid, the bladder including a first layer and a second layer, wherein, the first layer is made of a first polyurethane material having a Shore A hardness of less than 80 determined according to ASTM D 2240 and obtained by reacting a first isocyanate component with a first polyol component, said first polyol component having a nominal functionality of at least 2.0 and OH value ranging be-tween 20 mg KOH/g to 100 mg KOH/g, and the second layer is made of a second polyurethane material having a Shore D hard-ness of at least 40 determined according to ASTM D 2240 and obtained by reacting a second isocyanate component with a second polyol component, said second polyol component having a nominal functionality of at least 2.0 and OH value ranging between 20 mg KOH/g to 1000 mg KOH/g.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

Multilayer Structure

An aspect of the present invention is embodiment 1, directed towards a multilayer structure comprising
(A) a first layer made of a first polyurethane material having a Shore A hardness of less than 80 determined according to ASTM D 2240 and obtained by reacting a first isocyanate component with a first polyol component, said first polyol component comprising a first polyether polyol having a nominal functionality of at least 2.0 and OH value ranging between 20 mg KOH/g to 100 mg KOH/g, and
(B) a second layer made of a second polyurethane material having a Shore D hardness of at least 40 determined according to ASTM D 2240 and obtained by reacting a second isocyanate component with a second polyol component, said second polyol component comprising at least one polyol having a nominal functionality of at least 2.0 and OH value ranging between 20 mg KOH/g to 1000 mg KOH/g.

In an embodiment, the multilayer structure in the embodiment 1 does not contain any adhesive for binding together the first layer and the second layer. In another embodiment, the first polyurethane material and the second polyurethane material are not thermoplastics, but thermoset PU materials.

First Layer or Base Layer

In an embodiment, the first layer in the embodiment 1 is a first polyurethane (PU) material having a Shore A hardness of less than 80 determined according to ASTM D 2240. In another embodiment, the first PU material has a Shore A hardness in between 30 to 80, or in between 40 to 80, or in between 40 to 75. In yet another embodiment, the first PU material has a Shore A hardness in between 50 to 75, or in between 50 to 70, or in between 55 to 70, or in between 60 to 70.

In one embodiment, the first PU material in the embodiment 1 is obtained by reacting the first isocyanate component with first polyol component, said first polyol component comprising a first polyether polyol having a nominal functionality of at least 2.0 and OH value ranging between 20 mg KOH/g to 100 mg KOH/g. In another embodiment, the first PU material in the embodiment 1 is a PU elastomer. Said otherwise, no blowing agent is added for obtaining the first PU material. In the similar manner, the second PU material in the embodiment 1 is also a PU elastomer.

In another embodiment, the first isocyanate component in the embodiment 1 is selected from aromatic and aliphatic isocyanates. Suitable isocyanates, whether aliphatic and/or aromatic, include monomeric, polymeric, prepolymers thereof and modified isocyanates thereof. By the term “polymeric”, it is referred to the polymeric grade of the aliphatic and/or aromatic isocyanate comprising, independently of each other, different oligomers and homologues. Suitable modified isocyanates include, such as but not limited to, uretonimine modified, carbodiimide modified, isocyanates comprising biuret and/or isocyanurate groups.

In an embodiment, the first isocyanate component in the embodiment 1 is an aliphatic isocyanate comprising 6 to 100 carbon atoms linked in a straight chain or cyclized and having at least two reactive isocyanate groups. Suitable aliphatic isocyanates can be selected from tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocyanatomethylcyclohexane isocyanates, isocyanatoethylcyclohexane isocyanates, bis(isocyanatomethyl)cyclohexane diisocyanates, 4,4′- and 2,4′-bis(isocyanato-methyl) dicyclohexane, isophorone diisocyanate and 4,4′-Diisocyanatodicyclohexylmethane.

In another embodiment, the first isocyanate component in the embodiment 1 is an aromatic isocyanate selected from toluene diisocyanate; diphenylmethane diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate, and 1,3,5-triisopropyl benzene-2,4,6-triisocyanate.

In another embodiment, the aromatic isocyanate is selected from toluene diisocyanate; diphenylmethane diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; and 1-methyl-3,5-diethylphenylene-2,4-diisocyanate. In yet another embodiment, it is selected from toluene diisocyanate; diphenylmethane diisocyanate; m-phenylene diisocyanate and 1,5-naphthalene diisocyanate. In still another embodiment, the aromatic isocyanate is diphenylmethane diisocyanate or MDI.

MDI is available in three different isomeric forms, 2,2′-MDI, 2,4′-MDI and 4,4′-MDI. MDI can be classified into monomeric MDI and polymeric MDI referred to as technical MDI. Polymeric MDI includes oligomeric species and MDI isomers, as above. Thus, polymeric MDI may contain a single MDI isomer or isomer mixtures of two or three MDI isomers, the balance being oligomeric species. Polymeric MDI tends to have isocyanate functionalities of higher than 2.0. The isomeric ratio as well as the amount of oligomeric species can vary in wide ranges in these products. For instance, polymeric MDI may typically contain 30 wt.-% to 80 wt.-% of MDI isomers, the balance being said oligomeric species. The MDI isomers are often a mixture of 4,4′-MDI, 2,4′-MDI and very low levels of 2,2′-MDI. The first isocyanate component in the embodiment 1 can be a prepolymer based on the above MDI grades as well.

In an embodiment, the first isocyanate component in the embodiment 1 may further comprise of ingredients which are non-reactive towards isocyanate groups. Suitable ingredients include, such as but not limited to, catalysts, plasticizers, and antifoams, as described herein. In one embodiment, the first isocyanate component comprises a non-phthalate plasticizer. Di-isononyl-cyclohexane-1,2-dicarboxylate is an example of a suitable non-phthalate plasticizer that can be used in the first isocyanate component in the embodiment 1. These ingredients may be added in any amounts. However, in an embodiment, the ingredients are present in an amount in between 10 wt. % to 50 wt. %, based on the total weight of the first isocyanate component.

In an embodiment, the first polyol component in the embodiment 1 comprises a first polyether polyol having a nominal functionality of at least 2.0 and OH value ranging between 20 mg KOH/g to 100 mg KOH/g. In another embodiment, the first polyether polyol in the embodiment 1 has a nominal functionality in between 2.0 to 4.0, or in between 2.0 to 3.8, or in between 2.2 to 3.8. In yet another embodiment, the first polyether polyol in the embodiment 1 has a nominal functionality in between 2.2 to 3.5, or in between 2.5 to 3.5, or in between 2.5 to 3.3. In still another embodiment, the first polyether polyol in the embodiment 1 has a nominal functionality in between 2.7 to 3.3, or in between 2.7 to 3.1, or in between 2.9 to 3.1.

In one embodiment, the first polyether polyol in the embodiment 1 has OH value in between 20 mg KOH/g to 80 mg KOH/g, or in between 20 mg KOH/g to 60 mg KOH/g, or in between 20 mg KOH/g to 50 mg KOH/g. In another embodiment, the first polyether polyol in the embodiment 1 has OH value in between 30 mg KOH/g to 50 mg KOH/g, or in between 30 mg KOH/g to 40 mg KOH/g. In the present context, OH value is determined using DIN 53240-1. Alternatively, other known methods may also be employed for determining the OH value.

Suitable first polyether polyol in the embodiment 1 is obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are selected such that the nominal functionality of the resulting polyether polyol is in between 2.0 to 4.0. Optionally, a mixture of suitable starter molecules is also used.

Starter molecules for first polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

In one embodiment, amine containing starter molecules are selected from ethylenediamine, phenylenediamines, toluenediamine and isomers thereof.

Hydroxyl-containing starter molecules are selected from trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides can be used singly, alternatingly in succession or as mixtures. In one embodiment, the alkylene oxides are propylene oxide and/or ethylene oxide. In other embodiment, the alkylene oxides are mixtures of ethylene oxide and propylene oxide that comprise more than 50 wt.-% of propylene oxide.

In another embodiment, the first polyether polyol in the embodiment 1 may be capped. The term “capped”, as used herein, means that one or more terminals of the first polyether polyol is occupied by, such as but not limited to, an alkylene oxide group. For instance, the first polyether polyol may be capped with ethylene oxide. In a similar manner, the first polyether polyol may be capped with ethylene oxide, propylene oxide, butylene oxide, and combinations thereof.

In an embodiment, the first polyether polyol in the embodiment 1 has glycerol as the hydroxyl containing starter molecule with alkylene oxide being ethylene oxide and propylene oxide, having a nominal functionality in between 2.9 to 3.1 and OH value in between 30 mg KOH/g to 40 mg KOH/g.

In one embodiment, the first polyol component further comprises at least one of chain extenders, plasticizers, catalysts, antifoams and molecular sieves.

Suitable chain extenders in the first polyol component have a molecular weight in between 40 g/mol to 499 g/mol. In an embodiment, the chain extender in the first polyol component in the embodiment 1 can be selected from ethylene glycol, 1,2-propanediol, 1,3-propanediol, 1-5 pentanediol, 1,6-hexanediol, 1,10-decanediol, 1,2-dihydroxycyclohexane, 1,3-dihydroxycyclohexane, 1,4-dihydroxycyclohexane, diethylene glycol, 1,4-butanediol, bis(2-hydroxy-ethyl)hydroquinone, dipropylene glycol, glycerol, diethanolamine, and triethanolamine.

In another embodiment, the chain extender in the first polyol component in the embodiment 1 can be selected from ethylene glycol, 1,2-propanediol, 1,3-propanediol, 1-5 pentanediol, 1,6-hexanediol, 1,10-decanediol, 1,2-dihydroxycyclohexane, 1,3-dihydroxycyclohexane, 1,4-dihydroxycyclohexane, diethylene glycol, 1,4-butanediol, and 1,6-hexanediol. In yet another embodiment, the chain extender in the first polyol component in the embodiment 1 can be selected from ethylene glycol, 1,3-dihydroxycyclohexane, 1,4-dihydroxycyclohexane, diethylene glycol, 1,4-butanediol, and 1,6-hexanediol. In still another embodiment, the chain extender in the first polyol component in the embodiment 1 is diethylene glycol and/or 1,4-butanediol.

Suitable amounts of the chain extender in the first polyol component are well known to the person skilled in the art. In an embodiment, the chain extender in the first polyol component in the embodiment 1 is present in an amount in between 1 wt. % to 20 wt. % based on the total weight of the first polyol component. In one embodiment, the chain extender in the first polyol component in the embodiment 1 is present in between 1 wt. % to 20 wt. %, or in between 1 wt. % to 18 wt. %, or in between 3 wt. % to 18 wt. %, or in between 3 wt. % to 16 wt. %, or in between 3 wt. % to 14 wt. %, or in between 3.5 wt. % to 12 wt. %.

Suitable plasticizers in the first polyol component in the embodiment 1 include, but are not limited to, derivatives of abietic, acetic acid, adipic acid, azelaic acid, benzoic acid, butiene, polyphenol, citric acid, epoxy, fumaric acid, glutaric acid, glycerine, glycol, linear dibasic acid, petroleum, isobutyric, isophthalate, lactam, maleic acid, myristic acid, nitrile, oleic acid, palmitic acid, paraffin, pelargonic acid, pentaerythritol, phenoxy, phosphoric acid, polyester, ricinoleic acid, sebacic acid, stearic acid, styrene, sucrose, sulfonic acid, tall oil, and trimellitate acid. In one embodiment, the plasticizer in the embodiment 1 can be selected from 2,2,4-trimethyl-1,3-pentanediol diisobutyrate (TXIB) and tris-decyl benzene-1,2,4-tricarboxylate or tridecyl trimellitate (TDTM). The plasticizers may be used alone or in the form of a mixture of two or more plasticizers.

In one embodiment, the plasticizers in the first polyol component in the embodiment 1 is present in an amount less than 40 wt. %, based on the total weight of the first polyol component. In another embodiment, the plasticizer in the first polyol component in the embodiment 1 is present in an amount in between 10 wt. % to 40 wt. %, or in between 10 wt. % to 30 wt. %.

Suitable antifoams in the first polyol component in the embodiment 1 include ethylene oxide-propylene oxide block copolymer, alkoxylated fatty alcohol, polysiloxane, adduct of alkoxylated alcohol and polysiloxane, and mixtures thereof.

Alkoxylated fatty alcohols are compounds obtained by alkoxylation of fatty alcohols. Suitable fatty alcohol has a hydrocarbon chain having 6 to 22 carbon atoms which is either saturated or unsaturated hydrocarbon chain. The alkylene oxide is preferably selected from the group consisting of ethylene oxide, propylene oxide, and butylene oxide. The alkylene oxide is either a single alkylene oxide or a mixture of alkylene oxides. The alkoxylation of the fatty alcohol may take place blockwise or in random distribution. If the alkoxylation is blockwise, the number of repeating units in the alkylene deriving from a mixed alkylene oxide ranges from 3 to 100.

Polysiloxane, as used herein includes silicone in its broadest sense, that is, any polymeric structure that contains repeating silicon-oxygen groups in the backbone, side chains or cross links regardless of the substitution on the silicon atom, preferably the Polysiloxane is an organic polysiloxane. Suitable organic polysiloxanes are selected from poly(alkylsiloxane), poly(alkoxysiloxane), poly(arylsiloxane), poly(aryloxysiloxane), poly(alicyclicsiloxane) and mixtures thereof. The awl, aralkyl and aryloxy moieties which may be substituents on the siloxanes include phenyl, chlorophenyl, biphenyl, naphthyl, tolyl, ethylphenyl, propylphenyl and phenyloxy. The alicyclic rings are in particular 5- or 6-membered and may be either unsubstituted or alkyl or halogen-substituted. It is also possible to use polysiloxanes that carry cyano or aldehyde groups, such as cyanoalkylpolysiloxanes, for example poly(cyanomethyl)methylsiloxane, poly(2-cyanoethyl)methylsiloxane, poly(3-cyanopropyl)methylsiloxane, poly(4-cyanobutyl)methylsiloxane, poly(5-cyanopentyl)methylsiloxane, poly(cyanomethyl)ethylsiloxane and poly(cyanoethyl)-ethylsiloxane.

For the adduct of alkoxylated alcohol and polysiloxane as antifoam, the alcohol has a hydrocarbon chain having 1 to 22 carbon atoms. In one embodiment, the adduct of alkoxylated fatty alcohol, as described hereinabove, and polysiloxane, as described hereinabove, can also be used.

The antifoams may be present in less than 5.0 wt. %, based on the total weight of the first polyol component. In one embodiment, the antifoam in the first polyol component in the embodiment 1 is present in an amount in between 0.01 wt. % to 2.0 wt. %.

Molecular sieves are used as water scavengers. Suitable amounts of the molecular sieves in the first polyol component in the embodiment 1 are in between 0.1 wt. % to 5.0 wt. %, based on the total weight of the first polyol component.

In another embodiment, the first polyol component in the embodiment 1 may further comprise additives. Suitable additives for this purpose can be selected from flame retardants, dyes, pigments, IR absorbing materials, surfactants, stabilizers, antistats, fungistats, bacteriostats, hydrolysis controlling agents, curing agents, and antioxidants. Mixtures of one or more of these additives can also be used.

In another embodiment, the first polyol component in the embodiment 1 may further comprise of additional polyols, which are different than the first polyether polyol. Suitable additional polyols include, such as but not limited to, polyether polyol (i), polyether polyol (ii), and polymer polyol (iii), as described herein. Polyester polyols, in general, may also be used as additional polyols in the first polyol component.

Suitable polyester polyols include polyester diols prepared, for example, from dicarboxylic acids having from 2 to 12 carbon atoms and polyhydric alcohols. Examples of suitable dicarboxylic acids include aliphatic dicarboxylic acids such as succinic acid, maleic acid, glutaric acid, adipic acid, suberic acid, azelaic acid, and sebacic acid, and aromatic dicarboxylic acids such as phthalic acid, isophthalic acid and terephthalic acid. The dicarboxylic acids may be used individually or as mixtures, for example in the form of a succinic acid, glutaric acid and adipic acid mixture. To produce the polyester diols, it may be advantageous to use the corresponding dicarboxylic acid derivatives such as carboxylic diesters having from 1 to 4 carbon atoms in the alcohol radical, carboxylic anhydrides or carboxylic acid chlorides instead of the dicarboxylic acids. Examples of polyhydric alcohols are glycols having 2 to 10 carbon atoms, such as ethylene glycol, diethylene glycol, butane-1,4-diol, pentane-1,5-diol, hexane-1,6-diol, decane-1,10-diol, dodecane-1,12-diol, 2,2-dimethylpropane-1,3-diol, propane-1,3-diol and dipropylene glycol. According to the desired properties, the polyhydric alcohol may be used alone or optionally in a mixture with one another. Also suitable are condensation products of hydroxycarboxylic acids, for example hydroxycaproic acid, and polymerization products of cyclic lactones, for example optionally substituted caprolactones.

In an embodiment, the first PU material in the embodiment 1 is obtained by reacting the first isocyanate component and the first polyol component at an index ranging between 70 to 120. In another embodiment, the first PU material in the embodiment 1 is obtained by reacting the first isocyanate component and the first polyol component at an index ranging between 80 to 120, or in between 80 to 110, or in between 90 to 110. In still another embodiment, the first PU material in the embodiment 1 is obtained by reacting the first isocyanate component and the first polyol component at an index ranging between 95 to 110, or in between 95 to 105. In the present context, the index of 100 corresponds to one isocyanate group per one isocyanate reactive group.

Second Layer

In an embodiment, the second layer in the embodiment 1 is made of a second PU material having a Shore D hardness of at least 40 determined according to ASTM D 2240 and obtained by reacting a second isocyanate component with a second polyol component, said second polyol component comprising at least one polyol having a nominal functionality of at least 2.0 and OH value ranging between 20 mg KOH/g to 1000 mg KOH/g.

In one embodiment, the second PU material has a Shore D hardness ranging of at least 40, determined according to ASTM D 2240. In another embodiment, the second PU material in the embodiment 1 has a Shore D hardness ranging between 40 to 80, or in between 50 to 80, or in between 50 to 70. In another embodiment, the second PU material in the embodiment 1 has a Shore D hardness ranging between 60 to 70.

In an embodiment, the second isocyanate component is selected from aromatic and aliphatic isocyanates. Suitable second isocyanate components can be selected from the aromatic and aliphatic isocyanates as described above for the first isocyanate component. In another embodiment, both the first isocyanate component and the second isocyanate component may be same or different. Similar to the first isocyanate component, the second isocyanate component may also further comprise of ingredients which are non-reactive towards isocyanate groups. Suitable ingredients include, such as but not limited to, catalysts, plasticizers, and antifoams, as described herein. In one embodiment, the second isocyanate component comprises a non-phthalate plasticizer. Di-isononyl-cyclohexane-1,2-dicarboxylate is an example of a suitable non-phthalate plasticizer that can be used in the second isocyanate component in the embodiment 1. These ingredients may be added in any amounts. However, in an embodiment, the ingredients are present in an amount in between 10 wt. % to 50 wt. %, based on the total weight of the second isocyanate component.

In one embodiment, the polyol in the embodiment 1 is selected from
(i) a polyether polyol having a nominal functionality ranging between 2.0 to 3.5 and OH value ranging between 20 mg KOH/g to 100 mg KOH/g,
(ii) a polyether polyol having a nominal functionality ranging between 2.5 to 5.0 and OH value ranging between 300 mg KOH/g to 1000 mg KOH/g, and
(iii) a polymer polyol having a nominal functionality ranging between 2.0 to 8.0 and OH value in between 20 mg KOH/g to 1000 mg KOH/g.

In an embodiment, the polyether polyol (i) in the polyol in the embodiment 1 has a nominal functionality ranging between 2.0 to 3.0 and OH value ranging between 20 mg KOH/g to 100 mg KOH/g. In another embodiment, the polyether polyol (i) in the polyol in the embodiment 1 has a nominal functionality ranging between 2.0 to 3.0 and OH value ranging between 20 mg KOH/g to 60 mg KOH/g.

Suitable polyether polyol (i) in the polyol in the embodiment 1 is obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are selected such that the nominal functionality of the resulting polyether polyol is in between 2.0 to 3.5. Optionally, a mixture of suitable starter molecules is also used.

Starter molecules for polyether polyol (i) include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

In one embodiment, amine containing starter molecules are selected from ethylenediamine, phenylenediamines, toluenediamine and isomers thereof.

Hydroxyl-containing starter molecules are selected from trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides can be used singly, alternatingly in succession or as mixtures. In one embodiment, the alkylene oxides are propylene oxide and/or ethylene oxide. In other embodiment, the alkylene oxides are mixtures of ethylene oxide and propylene oxide that comprise more than 50 wt.-% of propylene oxide.

In another embodiment, the polyether polyol (i) in the embodiment 1 may be capped. The term “capped”, as used herein, means that one or more terminals of the polyether polyol (i) is occupied by, such as but not limited to, an alkylene oxide group. For instance, the polyether polyol (i) may be capped with ethylene oxide. In a similar manner, the polyether polyol (i) may be capped with ethylene oxide, propylene oxide, butylene oxide, and combinations thereof.

In an embodiment, the polyether polyol (i) is selected from at least one of:
(ia) polyether polyol having glycerol as the hydroxyl containing starter molecule with alkylene oxide being ethylene oxide and propylene oxide, having a nominal functionality in between 2.9 to 3.1 and OH value in between 30 mg KOH/g to 40 mg KOH/g,
(ib) polyether diol obtained as ethylene oxide-propylene oxide copolymer having an OH value in between 50 mg KOH/g to 60 mg KOH/g, and
(ic) polyether polyol having glycerol as the hydroxyl containing starter molecule with alkylene oxide being ethylene oxide and propylene oxide, having a nominal functionality in between 2.9 to 3.1 and OH value in between 25 mg KOH/g to 30 mg KOH/g.

The amount of the polyether polyol (i) in the polyol in the embodiment 1 is in between 20 wt. % to 80 wt. %, based on the total weight of the second polyol component.

In an embodiment, the polyether polyol (ii) in the polyol in the embodiment 1 has a nominal functionality ranging between 2.5 to 5.0 and OH value ranging between 300 mg KOH/g to 1000 mg KOH/g. In another embodiment, the polyether polyol (ii) in the polyol in the embodiment 1 has a nominal functionality ranging between 2.5 to 4.5 and OH value ranging between 300 mg KOH/g to 1000 mg KOH/g. In still another embodiment, the polyether polyol (ii) in the polyol in the embodiment 1 has a nominal functionality ranging between 3.0 to 4.5 and OH value ranging between 300 mg KOH/g to 1000 mg KOH/g.

Suitable polyether polyol (ii) in the polyol in the embodiment 1 is obtained by known processes, for example via anionic polymerization of alkylene oxides with the addition of at least one starter molecule comprising reactive hydrogen atoms, in the presence of catalysts. If mixtures of starter molecules with different functionality are used, fractional functionalities can be obtained. The catalysts can be alkali metal hydroxides, for example sodium hydroxide or potassium hydroxide, or alkali metal alcoholates, for example sodium methanolate, sodium ethanolate or potassium ethanolate or potassium isopropanolate, or in the case of a cationic polymerization, the catalysts can be Lewis acids, for example antimony pentachloride, boron trifluoride etherate or bleaching earth. It is also possible to use aminic alkoxylation catalysts, for example dimethylethanolamine (DMEOA), imidazole and imidazole derivatives. The catalysts can moreover also be double-metal cyanide compounds, which are known as DMC catalysts.

The alkylene oxides are one or more compounds having from 2 to 4 carbon atoms in the alkylene moiety, for example tetrahydrofuran, propylene 1,2-oxide, ethylene oxide, or butylene 1,2- or 2,3-oxide, in each case alone or in the form of a mixture. In one embodiment, the alkylene oxide comprises ethylene oxide and/or propylene 1,2-oxide.

Starter molecules that can be used are compounds containing hydroxyl groups or containing amine groups, for example ethylene glycol, diethylene glycol, glycerol, trimethylolpropane, pentaerythritol, sugar derivatives, for example sucrose, hexitol derivatives, for example sorbitol, methylamine, ethylamine, isopropylamine, butylamine, benzylamine, aniline, toluidine, toluenediamine (TDA), naphthylamine, ethylenediamine, diethylenetriamine, 4,4′-methylenedianiline, 1,3,-propanediamine, 1,6-hexanediamine, ethanolamine, diethanolamine, triethanolamine, and also other di- or polyhydric alcohols or mono- or polyfunctional amines. These high-functionality compounds are solid under the usual alkoxylation reaction conditions, and it is therefore usual to alkoxylate these together with co-initiators. Examples of suitable co-initiators are water, polyhydric lower alcohols, e.g. glycerol, trimethylolpropane, pentaerythritol, diethylene glycol, ethylene glycol, propylene glycol and homologs of these. Examples of other co-initiators that can be used are: organic fatty acids, fatty acid monoesters and fatty acid methylesters, for example oleic oil, stearic acid, methyl oleate, methyl stearate or bio-diesel.

Suitable starter molecules for the production of polyether polyol (ii) comprise sorbitol, sucrose, ethylenediamine, TDA, trimethylolpropane, pentaerythritol, glycerol, biodiesel, diethylene glycol or a mixture thereof. In one embodiment, the starter molecules comprise sucrose, glycerol, TDA, pentaerythritol, ethylenediamine or a mixture thereof.

In another embodiment, the polyether polyol (ii) in the polyol in the embodiment 1 may be capped. The term “capped”, as used herein, means that one or more terminals of the polyether polyol (ii) is occupied by, such as but not limited to, an alkylene oxide group. For instance, the polyether polyol (ii) may be capped with ethylene oxide. In a similar manner, the polyether polyol (ii) may be capped with ethylene oxide, propylene oxide, butylene oxide, and combinations thereof.

In one embodiment, the polyether polyol (ii) in the polyol in the embodiment 1 is selected from at least one of:
(iia) polyether polyol having sucrose and glycerol as the starter molecule and propylene oxide as the alkylene oxide, having a nominal functionality in between 3.9 to 4.1 and OH value in between 350 mg KOH/g to 360 KOH/g,
(iib) polyether polyol having ethylenediamine as the starter molecule and propylene oxide as the alkylene oxide, having a nominal functionality in between 3.9 to 4.1 and OH value in between 765 mg KOH/g to 775 KOH/g,
(iic) polyether polyol having TDA as the starter molecule and propylene oxide as the alkylene oxide, having a nominal functionality in between 3.9 to 4.1 and OH value in between 385 mg KOH/g to 395 KOH/g, and
(iid) polyether polyol having glycerol as the starter molecule and propylene oxide as the alkylene oxide, having a nominal functionality in between 2.9 to 3.1 and OH value in between 930 mg KOH/g to 940 KOH/g.

The polyether polyol (ii) in the polyol component in the embodiment 1 is present in an amount in between 20 wt. % to 60 wt. %, based on the total weight of the second polyol component. In an embodiment, the polyether polyol (ii) in the polyol in the embodiment 1 is present in an amount in between 20 wt. % to 50 wt. %, or in between 10 wt. % to 50 wt. %.

Suitable polymer polyols (iii) in the polyol in the embodiment can be selected from styrene-acrylonitrile (SAN) polymer polyols, polyurea suspension (PHD) polymer modified polyols and polyisocyanate polyaddition (PIPA) polymer modified polyols.

SAN polymer polyols are known in the art and are disclosed in Ionescu's Chemistry and Technology of Polyols and Polyurethanes, 2nd Edition, 2016 by Smithers Rapra Technology Ltd. In the SAN polymer polyols, a carrier polyol is the polyol in which the in-situ polymerization of olefinically unsaturated monomers is carried out, while macromers are polymeric compounds which have at least one olefinically unsaturated group in the molecule and are added to the carrier polyol prior to the polymerization of the olefinically unsaturated monomers.

The SAN polymer polyols have a nominal functionality in between 2.0 to 8.0 and OH value in between 20 mg KOH/g to 1000 mg KOH/g.

The SAN polymer polyols are usually prepared by free-radical polymerization of the olefinically unsaturated monomers, preferably acrylonitrile and styrene, in a polyether polyol or polyester polyol, usually referred to as carrier polyol, as continuous phase. These polymer polyols are prepared by in-situ polymerization of acrylonitrile, styrene or mixtures of styrene and acrylonitrile, e.g. in a weight ratio of from 90:10 to 10:90 (styrene:acrylonitrile), or from 70:30 to 30:70 (styrene:acrylonitrile), using methods analogous to those described in DE 1111394, DE 1222669, DE 1152536 and DE 1152537.

The characteristics of the carrier polyol are determined partly by the desired properties of the final polyurethane material to be formed by the SAN polymer polyol. Carrier polyols are conventional polyols having an average functionality in between 2.0 to 8.0, or in between 2.0 to 3.5, and OH value in between 20 mg KOH/g to 800 mg KOH/g, or in between 20 mg KOH/g to 500 mg KOH/g, or in between 20 to 300 mg KOH/g, or in between 20 to 50 mg KOH/g.

In an embodiment, the carrier polyol can be a suitable polyether polyol. Starter substance that are used include polyfunctional alcohols such as glycerol, trimethylolpropane or sugar alcohols such as sorbitol, sucrose or glucose, aliphatic amines, such as ethylenediamine, or aromatic amines such as toluenediamine (TDA), diphenylmethanediaimine (MDA) or mixtures of MDA and polyphenylene-polymethylenepolyamines. As alkylene oxides, use is made of propylene oxide or mixtures of ethylene oxide and propylene oxide. Such SAN polymer polyols have a solid content in between 10 wt.-% to 60 wt.-%, or in between 10 wt.-% to 40 wt.-%, or in between 20 wt.-% to 40 wt.-%, based on the total weight of the SAN polymer polyol.

In another embodiment, polyether polyols having an average functionality in between 2.0 to 8.0, and a hydroxyl number in between 20 to 100 mg KOH/g are employed as carrier polyols. These polyether polyols are prepared by the addition of alkylene oxides onto H-functional starter substances, for example glycerol, trimethylolpropane or glycols, such as ethylene glycol or propylene glycol. As catalysts for the addition reaction of the alkylene oxides, it is possible to use bases, hydroxides of alkali metals, or multimetal cyanide complexes, known as DMC catalysts.

In an embodiment, mixtures of at least two polyols, in particular at least two polyether polyols, can also be used as carrier polyols.

In order to initiate the free-radical polymerization, well known free-radical polymerization initiators, such as but not limited to, peroxides, azo compounds, persulfates, perborates and per-carbonates can be used. Suitable free-radical polymerization initiators can be selected from dibenzoyl peroxide, lauroyl peroxide, t-amyl peroxy-2-ethylhexanoate, di-tert-butyl peroxide, diisopropyl peroxide carbonate, tert-butyl peroxy-2-ethylhexanoate, tert-butyl perpivalate, tert-butyl perneodecanoate, tert-butyl perbenzoate, tert-butyl percrotonate, tert-butyl perisobutyrate, tert-butyl peroxy-1-methylpropanoate, tert-butyl peroxy-2-ethylpentanoate, tert-butyl peroxyoctanoate and di-tert-butyl perphthalate, 2,2′-azobis(2, 4-dimethylvaleronitrile), 2,2′-azobisisobutyronitrile (AIBN), dimethyl-2, 2′-azobisisobutyrate, 2,2′-azobis(2-methylbutyronitrlle) (AMBN), 1,1′-azobis(1-cyclohexanecarbonitrlle) and mixtures thereof.

Moderators, also referred to as chain transfer agents, can also be used for preparing SAN polymer polyols. The use and the function of these moderators is described, for example, in U.S. Pat. No. 4,689,354, EP 0 365 986, EP 0 510 533 and EP 0 640 633, EP 008 444, EP 0731 118. The moderators effect a chain transfer of the growing free radical and, thus, reduce the molecular weight of the copolymers being formed, as a result of which crosslinking between the polymer molecules is reduced, which influences the viscosity and the dispersion stability and also the filterability of the SAN polymer polyols. Moderators which are typically used for preparing SAN polymer polyols are alcohols such as 1-butanol, 2-butanol, isopropanol, ethanol, methanol, cyclohexanol, toluene, ethylbenzene, mercaptans, such as ethanethiol, 1-heptanethiol, 2-octanethiol, 1-dodecanethiol, thiophenol, 2-ethylhexyl thioglycolate, methyl thioglycolate, cyclohexyl mercaptan, halogenated hydrocarbons, such as carbon tetrachloride, carbon tetra-bromide, chloroform, methylene chloride and also enol ether compounds, morpholines, α-(benzoyloxy) styrene and mixtures thereof.

Organic solvents can also be employed for producing the SAN polymer polyols. Organic solvents allow the reduction of the viscosity during the process. Examples of organic solvents are methanol, ethanol, 1-propanol, iso-propanol, butanol, 2-butanol, iso-butanol, and the like. Organic solvents may be used by oneself and/or as mixtures of two or more organic solvents.

Macromers are linear or branched polyols which have number average molecular weights of at least 1000 g/mol and comprise at least one terminal, reactive olefinically unsaturated group. Macromers typically contain unsaturation levels between 0.1 to 2 mol per mol of polyol, or 0.8 mol to 1.2 mol per mol of polyol. The use and function of these macromers is described, for example, in U.S. Pat. Nos. 4,454,255, 4,458,038 and 4,460,715. During the free-radical polymerization, the macromers are built into the copolymer chain. This results in formation of block copolymers having a polyol block and a polymer block containing the used olefinically unsaturated monomers, which in the interface of continuous phase and disperse phase act as phase compatibilizers and suppress agglomeration of the SAN polymer polyol particles. The olefinically unsaturated group can be inserted into an existing polyol by reaction with an organic compound having both olefinically unsaturation and a group reactive with an active hydrogen containing group such as carboxyl, anhydride, isocyanate, epoxy, and the like. Suitable organic compounds having both olefinically unsaturation and a group reactive with an active hydrogen containing group are maleic acid, malic anhydrides, fumaric acid, fumaric anhydrides, butadiene monoxide, glycidyl methacrylate, allyl alcohols, isocyanatoethyl methacrylate, 3-isopropenyl-1,1-dimethylbenzyl isocyanate, and the like. A further route is the preparation of a polyol by alkoxylation of ethylene oxide, propylene oxide and butylene oxide using starter molecules having hydroxyl groups and ethylenic unsaturation. Examples of such macromers are described, for example, in WO 01/04178, US 249274 and U.S. Pat. No. 6,013,731.

Preformed stabilizer, or stabilizer containing seeds, can also be used as described in U.S. Pat. Nos. 4,242,249, 4,550,194, 4,997,857, 5,196,476, US 2006/0025491. Preformed stabilizers are described to improve SAN polymer polyol stability with lower viscosity at higher sol-id content. The preformed stabilizer may precipitate from the solution during the reaction to form a solid. The particle size of the solid is small, thereby the formed particles can function as seed in the SAN polymer polyol process. Preformed stabilizers are prepared by reacting the macromer, with the olefinically unsaturated monomers in presence of the free radical initiator in the carrier polyol, optionally an organic solvent, optionally a moderator, to form a copolymer, i.e. a preformed stabilizer.

The free-radical polymerization initiators, moderators, organic solvents, macromers and pre-formed stabilizers can be present in the SAN polymer polyol with respective preferred amounts in between 0.01 wt.-% to 25 wt.-%, based on the total weight of the SAN polymer polyol.

The SAN polymer polyols can be prepared by continuous, semi-batch and batch processes. Temperature for free-radical polymerization reaction for preparing the SAN polymer polyol, owing to the reaction rate and half-life of the initiators, is in between 70° C. to 150° C. and pressure is up to 2 MPa. In one embodiment, the reaction conditions for preparing the SAN polymer polyols are temperature in between 80° C. to 140° C. and pressure up to 1.5 MPa. The product is typically vacuum stripped by known methods, such as but not limited to, vacuum distillation, and can be stabilized by the addition of compounds such as, but not limited to, di-tert-butyl-para-cresol. The SAN polymer polyols can be further filtered to remove any formed large particles.

The SAN polymer polyols particle distribution has a maximum at from 0.05 μm to 8.0 μm. Commercially available SAN polymer polyols available under the tradename, such as but not limited to, Pluracol® from BASF can also be used for the purpose of the present invention.

In another embodiment, the PHD polymer modified polyol is usually prepared by in-situ polymerization of an isocyanate mixture with a diamine and/or hydrazine in a polyol, preferably a polyether polyol. Methods for preparing PHD polymer modified polyols are described in, for example, U.S. Pat. Nos. 4,089,835 and 4,260,530.

In yet another embodiment, the PIPA polymer modified polyol is usually prepared by the in-situ polymerization of an isocyanate mixture with a glycol and/or glycol amine in a polyol. Methods for preparing PIPA polymer modified polyols are described in, for example, U.S. Pat. Nos. 4,293,470 and 4,374,209.

The polymer solid content in PHD or PIPA polymer modified polyol is in between 3 wt.-% to 40 wt.-%, while the hydroxyl number is in between 20 mg KOH/g to 80 mg KOH/g.

In an embodiment, the polymer polyol (iii) in the polyol in the embodiment 1 is SAN polymer polyol having a nominal functionality in between 2.9 to 3.1, OH value in between 20 mg KOH/g to 30 mg KOH/g and a solid content in between 25 wt. % to 35 wt. %.

The polymer polyol (iii) in the polyol in the embodiment 1 is present in an amount in between 20 wt. % to 50 wt. %, based on the total weight of the second polyol component. In one embodiment, the polymer polyol (iii) in the polyol in the embodiment 1 is present in an amount in between 30 wt. % to 50 wt. %, or in between 30 wt. % to 40 wt. %.

In one embodiment, the polyol in the second polyol component in the embodiment 1 is selected from:
polyether polyol (i) selected from at least one of:
(ia) polyether polyol having glycerol as the hydroxyl containing starter molecule with alkylene oxide being ethylene oxide and propylene oxide, having a nominal functionality in between 2.9 to 3.1 and OH value in between 30 mg KOH/g to 40 mg KOH/g,
(ib) polyether diol obtained as ethylene oxide-propylene oxide copolymer having an OH value in between 50 mg KOH/g to 60 mg KOH/g, and
(ic) polyether polyol having glycerol as the hydroxyl containing starter molecule with alkylene oxide being ethylene oxide and propylene oxide, having a nominal functionality in between 2.9 to 3.1 and OH value in between 25 mg KOH/g to 30 mg KOH/g,
polyether polyol (ii) selected from at least one of:
(iia) polyether polyol having sucrose and glycerol as the starter molecule and propylene oxide as the alkylene oxide, having a nominal functionality in between 3.9 to 4.1 and OH value in between 350 mg KOH/g to 360 KOH/g,
(iib) polyether polyol having ethylenediamine as the starter molecule and propylene oxide as the alkylene oxide, having a nominal functionality in between 3.9 to 4.1 and OH value in between 765 mg KOH/g to 775 KOH/g,
(iic) polyether polyol having TDA as the starter molecule and propylene oxide as the alkylene oxide, having a nominal functionality in between 3.9 to 4.1 and OH value in between 385 mg KOH/g to 395 KOH/g, and
(iid) polyether polyol having glycerol as the starter molecule and propylene oxide as the alkylene oxide, having a nominal functionality in between 2.9 to 3.1 and OH value in between 930 mg KOH/g to 940 KOH/g, and
SAN polymer polyol (iii) having a nominal functionality in between 2.9 to 3.1, OH value in between 20 mg KOH/g to 30 mg KOH/g and a solid content in between 25 wt. % to 35 wt. %.

In one embodiment, the second polyol component further comprises at least one of chain extenders, plasticizers, catalysts, antifoams and molecular sieves. The chain extenders, plasticizers, catalysts, antifoams and molecular sieves are already described herein. Further, the amounts of the chain extenders, plasticizers, catalysts, antifoams and molecular sieves in the second polyol component are similar to the ones described herein.

Similarly, the second polyol component may further comprise additives, as described herein.

In an embodiment, the second PU material in the embodiment 1 is obtained by reacting the second isocyanate component and the second polyol component at an index ranging between 70 to 120. In another embodiment, the second PU material in the embodiment 1 is obtained by reacting the second isocyanate component and the second polyol component at an index ranging between 80 to 120, or in between 80 to 110, or in between 90 to 110. In still another embodiment, the second PU material in the embodiment 1 is obtained by reacting the second isocyanate component and the second polyol component at an index ranging between 95 to 110, or in between 95 to 105.

In one embodiment, there is no other layer in between the first layer and the second layer in the embodiment 1, as described herein. Said otherwise, the first layer completely encapsulates the second layer. Alternatively, the first layer may partially encapsulate the second layer in a manner that another intermediate layer of a material different than the first PU material and the second PU material is present. Suitable material making for the intermediate layer need not necessarily be made of a PU material, but any other polymeric material known to the person skilled in the art. For example, the intermediate layer can be made from a conventional rubber material, such as but not limited to, bromobutyl or chlorobutyl rubber.

In another embodiment, a thickness of the second layer is in between 1% to 30% of a thickness of the first layer, said thickness of the first layer ranging between 0.5 mm to 8.0 mm. The intermediate layer, if present, also has a thickness in between 1% to 20% of the thickness of the first layer.

In an embodiment, the multilayer structure in the embodiment 1 can have more than one layer made of the first PU material and/or the second PU material as described herein, for example 2, 3, 4, 5 or 6 layers made of the first PU material and/or the second PU material. If more than one layers of the first PU material and/or the second PU material are present, each of the said first PU material and second PU materials may be different or same. In one embodiment, different first PU materials are used for making the consecutive layers. Similarly, different second PU materials are used for making the consecutive layers.

In one embodiment, the multilayer structure in the embodiment 1 can have any shape and/or size suitable for the desired application. For instance, the multilayer structure can be molded to form a spherical shape, when used for making a sports ball.

Among others, the multilayer structure in the embodiment 1 has improved gas permeation levels. To determine the gas permeation levels, samples having known thickness are prepared. Nitrogen and oxygen permeation are evaluated once per sample. These gases are chosen as a good air representation. Permeation is then determined using Differential Pressure Method. In this method, an apparatus having two cells, one above the sample and one below, is chosen. Both cells are evacuated to vacuum, with the top cell being exposed to the gas. As the gas permeates the sample, the pressure in the lower cell rises. From the rise in pressure against time, the gas transmission rate can be determined. By combining this information with the thickness of the sample, the permeation rate can be determined.

Use

Another aspect of the present invention is embodiment 2, directed towards the use of the above multilayer structure for a pressurized bladder. Due to the advantageous properties of the multilayer structure in the embodiment 1, such as improved barrier performance including gas permeability, tensile modulus and creep, and flexibility, the multilayer structure can be shaped as a pressurized bladder. Pressurized bladders are typically used as an important structure in making sports ball. Suitable examples of the sports ball include, such as but not limited to, football and basketball. In the present context, tensile properties are determined in accordance with ASTM D412-16.

The multilayer structure in the embodiment 1, when used for pressurized bladders has a nitrogen gas transmission rate of less than 70 cm³m⁻²day⁻¹bar⁻¹. Owing to this very low transmission rate of the bladder, the sports ball can remain inflated for a longer duration yet having the properties similar to the ones obtained from conventional materials, for example bromobutyl rubber.

Another aspect of the present invention is embodiment 3, directed towards the pressurized bladder comprising the multilayer structure of the embodiment 1 and having a nitrogen gas transmission rate of less than 70 cm³m⁻²day⁻¹bar⁻¹.

Another aspect of the present invention is embodiment 4, directed towards a process for preparing the pressurized bladder of embodiment 3, said process comprising
(BL1) molding the first PU material in a mold to obtain the first layer,
(BL2) injecting the second PU material in the mold of step (BL1) to encapsulate the first layer, at least partially with the second layer,
(BL3) shaping the first layer and the second layer of step (BL2) in the mold to obtain the pressurized bladder.

In an embodiment, the first PU material and the second PU material in the embodiment 4 are obtained using conventional techniques known to the person skilled in the art. Once the first and second PU materials are obtained, they are subjected to suitable techniques for preparing the pressurized bladder.

In one embodiment, the process in the embodiment 4 is selected from injection molding, rotational molding, and slush molding. In another embodiment, the process in the embodiment 3 is rotational molding. A general description of the rotational molding can be referred from WO2006/000770, U.S. Pat. No. 8,357,324 B2, and U.S. Pat. No. 6,444,733 B1.

The rotational molding process is mainly used for making hollow plastic products. It can be used to produce a wide range of products with highly desirable characteristics and is relatively inexpensive when compared to other molding processes. Unlike the rotational molding for thermoplastics where the mold is heated by an external source (i.e. an oven) for the raw materials to change from solid (pellet or powder form) to molten plastic, the raw materials for both the first and second PU materials are liquid when injected into the mold where polymerization occurs. External heating of the mold is not necessary.

Said otherwise, the isocyanate component, i.e. first and second isocyanate component, and the isocyanate reactive component, i.e. first and second polyol component, are liquid at room temperature. The isocyanate reactive component may also be referred to as resin component. By room temperature, a temperature of 25±5° C. is referred. Alternately, the raw materials for the first and second PU materials can also be pre-heated, for instance upto a temperature as high as 75° C. The isocyanate component and the isocyanate reactive component for both the first and second PU material respectively, are then mixed and injected in a suitable mold to obtain the respective layers.

In one embodiment, a known amount of the raw materials for the first and second PU material respectively, are introduced into the mold which can rotate and/or at least rock back and forth about one or more axes. This is usually done via a two shot process which involves molding the first layer and subsequently the second layer. In another embodiment, the raw materials for the first PU material are injected in the mold and allowed sufficient conditions to react and polymerize, alongside rotation of the mold, to obtain the first layer. Subsequently, the raw materials for the second PU material are injected in the same mold and the second layer over the first layer is obtained. Sufficient conditions for PU formation are known to the person skilled in the art. Suitable temperature for PU formation range between 40° C. to 100° C.

In one embodiment, it is also possible that the first layer partially encapsulates the second layer. While, it is preferred that the second layer completely encapsulates the first layer, it is possible that the second layer partially encapsulates the first layer. In such a case, it is also possible that another intermediate layer of a material different than the first PU material and the second PU material is present. Suitable material for the intermediate layer need not necessarily be made of a PU material, but any other polymeric material, including both thermoplastic and thermosets, known to the person skilled in the art. For example, the intermediate layer can be made from a conventional plastic or rubber material, such as but not limited to, bromobutyl or chlorobutyl rubber.

In order to optimize the raw material distribution in the mold and obtain a uniform layer of the respective PU material, several parameters need to be optimized. For instance, rotational time and speed; reactivity profile and rheology of the raw materials; and starting temperature of the PU materials or raw materials, i.e. liquid raw materials at room temperature or at higher temperature, for e.g. upto 75° C., typically affect the rotational molding process of the present invention.

Suitable molds for this purpose can have any shape and size. For instance, a sphere shaped mold having an inlet for injecting the PU materials is suitable for obtaining the pressurized bladder. The pressurized bladder, thus obtained, can be used as sports ball. Advantageously, the pressurized bladder comprising the multilayer structure of the embodiment 1 prevents the need to have an additional material for winding and providing the necessary tensile properties, particularly tensile modulus. Such winding materials are widely used in conventional or state of the art materials for making sports ball. In the present invention, the necessary tensile properties are provided by the second PU material in the second layer in embodiment 1.

Although, any of the first and second PU materials can be introduced first in the mold, it is preferred that the softer PU material or the first PU material is first molded and then the harder PU material or the second PU material is introduced. Surprisingly, this arrangement of the PU materials results in significant improvement in the air permeation rate of the pressurized bladder while maintaining good dimensional stability under pressure. Further, the thickness of the second layer is between 1% to 30% of the thickness of the first layer, said thickness of the first layer ranging between 0.5 mm to 8.0 mm, provides for the required flexibility in the second layer.

The rotational molding process, as described herein, also results in an excellent mold texture of the PU materials, enables automation with minimal assembly requirement, is inexpensive and produces nearly zero waste.

Another aspect of the present invention is embodiment 5, directed towards a shaped article comprising the multilayer structure of the embodiment 1. The shaped article can be, for example, a pressurized bladder which is in turn used as a sports ball. The pressurized bladder is described in the embodiments 3 and 4, as above.

Another aspect of the present invention is embodiment 6, directed towards a process for preparing the shaped article of the embodiment 5, said process comprising at least:
(S1) molding the first PU material in the mold to obtain the first layer,
(S2) injecting the second PU material in the mold of step (BL1) to encapsulate the first layer, at least partially with the second layer,
(S3) shaping the first layer and the second layer of step (BL2) in the mold to obtain the pressurized bladder.

In an embodiment, the process of embodiment 6 is selected from injection molding, rotational molding, and slush molding. In another embodiment, the process of embodiment 6 is rotational molding, which has already been described in embodiment 4.

Another aspect of the present invention is embodiment 7, directed towards a sports ball comprising a bladder for enclosing a pressurized fluid, the bladder including a first layer and a second layer,
wherein, the first layer is made of the first PU material having a Shore A hardness of less than 80 determined according to ASTM D 2240 and obtained by reacting a first isocyanate component with a first polyol component, said first polyol component having a nominal functionality of at least 2.0 and OH value ranging between 20 mg KOH/g to 100 mg KOH/g, and
the second layer is made of the second polyurethane material having a Shore D hardness of at least 40 determined according to ASTM D 2240 and obtained by reacting a second isocyanate component with a second polyol component, said second polyol component having a nominal functionality of at least 2.0 and OH value ranging between 20 mg KOH/g to 1000 mg KOH/g.

In one embodiment, the bladder of the embodiment 7 is the pressurized bladder of the embodiment 3 and 4. Accordingly, the first layer, second layer, first PU material and the second PU material of the embodiment 1 are applicable for embodiment 7.

In another embodiment, the bladder in the embodiment 7 can be located within a casing that forms at least a portion of an exterior surface of the ball. In still another embodiment, a restriction structure is located between the casing and the bladder. While this is a typical description of a sports ball, it is possible that casing and/or restriction structure may or may not be present in the sports ball of the embodiment 7. A typical description of the sports ball is well known to the person skilled in the art, and include the sports ball described in, for example US 2020/0171359 A1, and U.S. Pat. No. 9,114,286 B2.

Suitable thickness of the second layer in the embodiment 7 is in between 1% to 30% of the thickness of the first layer, said thickness of the first layer ranging between 0.5 mm to 8.0 mm. For example, if the first layer has a thickness of 2.0 mm, the second layer can have a thickness anywhere between 0.02 mm to 0.6 mm. Surprisingly, the thickness of the first layer and the second layer, as described herein, results in the improved barrier performance in combination with the required flexibility and other mechanical properties desired in the typical sports ball. In particular, the nitrogen gas transmission rate of the bladder in the embodiment 7 is less than 70 cm³m⁻²day⁻¹bar⁻¹. Such low transmission rates are advantageous for application of the bladder of the embodiment 7 in sports ball and related applications.

Typically, the pressurized fluid includes air and/or nitrogen. Further, suitable pressure values inside the bladder are known to the person skilled in the art.

The presently claimed invention is illustrated in more detail by the following embodiments and combinations of embodiments which results from the corresponding dependency references and links:
I. A multilayer structure comprising
   (A) a first layer made of a first polyurethane material having a Shore A hardness of less than 80 determined according to ASTM D 2240 and obtained by reacting a first isocyanate component with a first polyol component, said first polyol component comprising a first polyether polyol having a nominal functionality of at least 2.0 and OH value ranging between 20 mg KOH/g to 100 mg KOH/g, and
   (B) a second layer made of a second polyurethane material having a Shore D hardness of at least 40 determined according to ASTM D 2240 and obtained by reacting a second isocyanate component with a second polyol component, said second polyol component comprising at least one polyol having a nominal functionality of at least 2.0 and OH value ranging between 20 mg KOH/g to 1000 mg KOH/g.
II. The multilayer structure according to embodiment I, wherein the first polyurethane material has a Shore A hardness ranging between 40 to 80 determined according to ASTM D 2240.
III. The multilayer structure according to embodiment I or II, wherein the first polyurethane material has a Shore A hardness ranging between 60 to 70 determined according to ASTM D 2240.
IV. The multilayer structure according to one or more of embodiments I to III, wherein the index of the first polyurethane material is in between 95 to 105.
V. The multilayer structure according to one or more of embodiments I to IV, wherein the index of the second polyurethane material is in between 95 to 105.
VI. The multilayer structure according to one or more of embodiments I to V, wherein the first polyether polyol has a nominal functionality in between 2.0 to 4.0 and a OH value ranging between 20 mg KOH/g to 50 mg KOH/g.
VII. The multilayer structure according to one or more of embodiments I to VI, wherein the second polyurethane material has a Shore D hardness ranging between 40 to 80 determined according to ASTM D 2240.
VIII. The multilayer structure according to one or more of embodiments I to VII, wherein the second polyurethane material has a Shore D hardness ranging between 60 to 70 determined according to ASTM D 2240.
IX. The multilayer structure according to one or more of embodiments I to VIII, wherein the polyol is selected from
   (i) a polyether polyol having a nominal functionality ranging between 2.0 to 3.5 and OH value ranging between 20 mg KOH/g to 100 mg KOH/g,
   (ii) a polyether polyol having a nominal functionality ranging between 2.5 to 5.0 and OH value ranging between 300 mg KOH/g to 1000 mg KOH/g, and
   (iii) a polymer polyol having a nominal functionality ranging between 2.0 to 8.0 and OH value ranging between 20 mg KOH/g to 1000 mg KOH/g.
X. The multilayer structure according to embodiment IX, wherein the polyether polyol (i) is present in an amount in between 20 wt. % to 80 wt. %, based on the total weight of the second polyol component.
XI. The multilayer structure according to embodiment IX or X, wherein the polyether polyol (ii) is present in an amount in between 20 wt. % to 60 wt. %, based on the total weight of the second polyol component.
XII. The multilayer structure according to one or more of embodiments IX to XI, wherein the polymer polyol (iii) is present in an amount in between 20 wt. % to 50 wt. %, based on the total weight of the second polyol component.
XIII. The multilayer structure according to one or more of embodiments I to XII, wherein the first isocyanate component is selected from an aliphatic isocyanate and an aromatic isocyanate.
XIV. The multilayer structure according to one or more of embodiments I to XIII, wherein the first isocyanate component comprises toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, 1,3,5-triisopropyl benzene-2,4,6-triisocyanate, mixtures thereof and prepolymers obtained therefrom.
XV. The multilayer structure according to one or more of embodiments I to XIV, wherein the first isocyanate component comprises methylene diphenyl diisocyanate and/or polymeric methylene diphenyl diisocyanate.
XVI. The multilayer structure according to one or more of embodiments I to XV, wherein the first isocyanate component comprises 2,2′-methylene diphenyl diisocyanate, 2,4′-methylene diphenyl diisocyanate, 4,4′-methylene diphenyl diisocyanate, mixtures thereof and prepolymers obtained therefrom.
XVII. The multilayer structure according to one or more of embodiments I to XVI, wherein the second isocyanate component comprises toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, 1,3,5-triisopropyl benzene-2,4,6-triisocyanate, mixtures thereof and prepolymers obtained therefrom.
XVIII. The multilayer structure according to one or more of embodiments I to XVII, wherein the second isocyanate component comprises methylene diphenyl diisocyanate and/or polymeric methylene diphenyl diisocyanate.
XIX. The multilayer structure according to one or more of embodiments I to XVIII, wherein the second isocyanate component comprises 2,2′-methylene diphenyl diisocyanate, 2,4′-methylene diphenyl diisocyanate, 4,4′-methylene diphenyl diisocyanate, mixtures thereof and prepolymers obtained therefrom.
XX. The multilayer structure according to one or more of embodiments I to XIX, wherein the first isocyanate component and the second isocyanate component, independent of each other, further comprise of di-isononyl-cyclohexane-1,2-dicarboxylate.
XXI. The multilayer structure according to one or more of embodiments I to XX, wherein the first polyol component and the second polyol component, independent of each other, further comprise at least one of chain extenders, plasticizers, catalysts, antifoams and molecular sieves.
XXII. The multilayer structure according to one or more of embodiments I to XXI, wherein the first polyol component and the second polyol component, independent of each other, further comprises additives.
XXIII. The multilayer structure according to embodiment XXII, wherein the additive is selected from flame retardants, dyes, pigments, IR absorbing materials, surfactants, stabilizers, antistats, fungistats, bacteriostats, hydrolysis controlling agents, curing agents, and antioxidants.
XXIV. Use of the multilayer structure according to one or more of embodiments I to XXIII for a pressurized bladder.
XXV. A pressurized bladder comprising the multilayer structure according to one or more of embodiments I to XXIII, said bladder having a nitrogen gas transmission rate of less than 70 cm³m⁻²day⁻¹bar⁻¹.
XXVI. A process for preparing a pressurized bladder according to embodiment XXV, said process comprising
   (BL1) molding the first polyurethane material in a mold to obtain the first layer,
   (BL2) injecting the second polyurethane material in the mold of step (BL1) to encapsulate the first layer, at least partially with the second layer,
   (BL3) shaping the first layer and the second layer of step (BL2) in the mold to obtain the pressurized bladder.
XXVII. A shaped article comprising the multilayer structure according to one or more of embodiments I to XXIII.
XXVIII. A process for preparing a shaped article according to embodiment XXVII, said process comprising at least:
   (S1) molding the first polyurethane material in a mold to obtain the first layer,
   (S2) injecting the second polyurethane material in the mold of step (S1) to obtain the second layer at least partially encapsulated by the first layer, and
   (S3) shaping the first layer and the second layer of step (S2) in the mold to obtain the shaped article.
XXIX. The process according to embodiment XXVIII, which is selected from injection molding, rotational molding, and slush molding.
XXX. The process according to embodiment XXVIII or XXIX, wherein the second layer is completely encapsulated by the first layer.
XXXI. The process according to one or more of embodiments XXVIII to XXX, wherein the shaped article is a sport ball.
XXXII. A sports ball comprising a bladder for enclosing a pressurized fluid, the bladder including a first layer and a second layer,
   wherein, the first layer is made of a first polyurethane material having a Shore A hardness of less than 80 determined according to ASTM D 2240 and obtained by reacting a first isocyanate component with a first polyol component, said first polyol component having a nominal functionality of at least 2.0 and OH value ranging between 20 mg KOH/g to 100 mg KOH/g, and
   the second layer is made of a second polyurethane material having a Shore D hardness of at least 40 determined according to ASTM D 2240 and obtained by reacting a second isocyanate component with a second polyol component, said second polyol component having a nominal functionality of at least 2.0 and OH value ranging between 20 mg KOH/g to 1000 mg KOH/g.
XXXIII. The sports ball according to embodiment XXXII, wherein a thickness of the second layer is in between 1% to 30% of a thickness of the first layer, said thickness of the first layer ranging between 0.5 mm to 8.0 mm.
XXXIV. The sports ball according to embodiment XXXII or XXXIII, wherein the bladder has a nitrogen gas transmission rate of less than 70 cm³m⁻²day⁻¹bar⁻¹.

### Examples

The presently claimed invention is illustrated by the non-restrictive examples which are as follows:

Raw Materials

Polyol (P)

| | |
|---|---|
| P1 | Polyether polyol having glycerol as the hydroxyl containing starter molecule with |
| | alkylene oxide being ethylene oxide and propylene oxide, having a nominal functionality |
| | in between 2.9 to 3.1 and OH value in between 30 mg KOH/g to 40 mg KOH/g, |
| | obtained from BASF |
| P2 | Polyether polyol having TDA as the starter molecule and propylene oxide as the alkylene |
| | oxide, having a nominal functionality in between 3.9 to 4.1 and OH value in |
| | between 385 mg KOH/g to 395 KOH/g, obtained from BASF |
| P3 | Polyether polyol having glycerol as the hydroxyl containing starter molecule with |
| | alkylene oxide being ethylene oxide and propylene oxide, having a nominal functionality |
| | in between 2.9 to 3.1 and OH value in between 25 mg KOH/g to 30 mg KOH/g, |
| | obtained from BASF |
| P4 | Polyether polyol having glycerol as the starter molecule and propylene oxide as the |
| | alkylene oxide, having a nominal functionality in between 2.9 to 3.1 and OH value in |
| | between 930 mg KOH/g to 940 KOH/g, obtained from BASF |
| P5 | SAN polymer polyol having a nominal functionality in between 2.9 to 3.1, OH value |
| | in between 20 mg KOH/g to 30 mg KOH/g and a solid content in between 25 wt. % |
| | to 35 wt. %, obtained from BASF |
| P6 | Polyether polyol having ethylenediamine as the starter molecule and propylene oxide |
| | as the alkylene oxide, having a nominal functionality in between 3.9 to 4.1 and OH |
| | value in between 765 mg KOH/g to 775 KOH/g, obtained from BASF |
| P7 | Polyether diol obtained as ethylene oxide-propylene oxide copolymer having an OH |
| | value in between 50 mg KOH/g to 60 mg KOH/g, obtained from Monument chemical |
| P8 | Polyether polyol having sucrose and glycerol as the starter molecule and propylene |
| | oxide as the alkylene oxide, having a nominal functionality in between 3.9 to 4.1 and |
| | OH value in between 350 mg KOH/g to 360 KOH/g, obtained from Carpenter Co. |

Isocyanate (ISO)

| | |
|---|---|
| ISO1 | Short chain prepolymer based on 4,4′-MDI having an NCO content of 23.0 wt. %, |
| | obtained from BASF |
| ISO2 | Polymeric MDI having an average functionality of 2.7, obtained from BASF |

Chain extender (CEx)

| | |
|---|---|
| CEx1 | 1,4-butanediol |
| CEx2 | Diethylene glycol |

Miscellaneous (plasticizers, catalyst, antifoam, and molecular sieves)

| | |
|---|---|
| M1 | di-isononyl-cyclohexane-1,2-dicarboxylate as plasticizer |
| M2 | 2,2,4-Trimethyl-1,3-pentanediol Diisobutyrate as plasticizer |
| M3 | Odourless mineral spirit as plasticizer |
| M4 | 1,4-Diazabicyclo[2.2.2]octane as catalyst |
| M5 | Copper based heat activated catalyst |
| M6 | Dimethyl silicone as antifoam |
| M7 | Molecular sieve paste as water scavenger |
| M8 | Zeolite type A structure in potassium-sodium form, having an effective pore opening |
| | of 3 Å, as water scavenger |

Standard Method

| | |
|---|---|
| DIN 53240-1 | OH value |
| ASTM D 2240 | Shore hardness |
| ASTM D412-16 | Tensile properties |

General Synthesis of PU Materials

The aforementioned raw materials were added in the amounts (all in wt. %) mentioned in Table 1 for both the first and second PU material respectively. For the first PU material, the isocyanate-side and the resin-side raw materials were mixed at room temperature, i.e. 25±5° C. Subsequently, the mixture was poured in a spherical mold having 10-inch diameter and rotated at approx. 10 rpm until complete polymerization or curing occurs. Similar steps were performed to obtain the second PU material.

TABLE 1
First PU material (FPU) and second PU material (SPU)

| | | | | |
|---|---|---|---|---|
| Ingredients | FPU 1 | SPU 1 | SPU 2 | SPU 3 |

Isocyanate-side (ISO)

| | | | | |
|---|---|---|---|---|
| ISO1 | 100 | — | 100 | — |
| ISO2 | — | 100 | — | 70 |
| M1 | — | — | — | 30 |

Resin-side (RESIN)

| | | | | |
|---|---|---|---|---|
| P1 | 94.21 | | 40.15 | — |
| P2 | — | 12.12 | — | — |
| P3 | — | 62.10 | — | — |
| P4 | — | 20.12 | — | — |
| P5 | — | — | 35 | — |
| P6 | — | — | 11.30 | 27.99 |
| P7 | — | — | — | 23.99 |
| P8 | — | — | — | 19.19 |
| CE1 | 4.5 | | 11.5 | — |
| CE2 | — | | — | — |
| M1 | — | — | — | — |
| M2 | — | — | — | 15.99 |
| M3 | — | — | — | 11.99 |
| M4 | — | 0.16 | — | — |
| M5 | 0.25 | — | — | — |
| M6 | 0.5 | — | — | — |
| M7 | 1.0 | — | — | — |
| M8 | — | 1.0 | 2.0 | 0.8 |

PU properties

| | | | | |
|---|---|---|---|---|
| Index | 95-105 | 95-105 | 95-105 | 95-105 |
| Mix ratio | 30:100 | 66:100 | 85:100 | 100:100 |
| (ISO:RESIN)* | | | | |
| Shore Hardness | 65 A | 66 D | 65 D | 65 D |

*calculated by weight

Gas Permeation Results

A multi-layered structure comprising first layer of FPU and second layer of SPU was prepared. For this, the samples were prepared by first casting a base layer made of FPU. Following cure of the base layer, the second layer was applied to one side of the sample using a draw down bar. The thickness of the second layer, which is thinner than the first layer, was varied and the N₂ and O₂ permeation data was reported in Table 2 below.

For comparison purpose (CE), a single layered structure was prepared from bromobutyl rubber in combination with natural rubber (BNR).

Samples, both inventive and comparative, having respective thicknesses mentioned in Table 2 were prepared. N₂ and O₂ permeation were evaluated once per sample. These gases were chosen as a good air representation. The method used to determine the permeation was the Differential Pressure Method. The apparatus had two cells, one above the sample and one below. Both cells were evacuated to vacuum, then the top cell was exposed to gas. As the gas permeates the sample, the pressure in the lower cell rises. From the rise in pressure against time, the gas transmission rate can be determined. By combining this information with the thickness of the sample, the permeation rate can be determined.

TABLE 2
Inventive and comparative samples for gas permeation results

| | | | | | N₂ | N₂ | O₂ | O₂ |
|---|---|---|---|---|---|---|---|---|
| | | | | | transmission | permeation | transmission | permeation |
| | | | Total | 2^{nd} | rate | (cm³ mm | rate | (cm³ mm |
| | | | sample | layer | (cm³ m⁻² | m⁻² | (cm³ m⁻² | m⁻² |
| | First | Second | thickness | thickness | day⁻¹ | day⁻¹ | day⁻¹ | day⁻¹ |
| Example | layer | layer | (mm) | (mm) | bar⁻¹) | bar⁻¹) | bar⁻¹) | bar⁻¹) |
| CE1 | BNR | nil | 0.68 | nil | 79 | 63 | n.d. | n.d. |
| CE2 | BNR | nil | 0.74 | nil | 100 | 68 | 16 | 11 |
| CE3 | FPU | nil | 1.28 | nil | 124 | 160 | 337 | 433 |
| IE1 | FPU | SPU1 | 1.40 | 0.17 | 11 | 16 | 14 | 19 |
| IE2 | FPU | SPU1 | 1.51 | 0.16 | 15 | 23 | 18 | 27 |
| IE3 | FPU | SPU2 | 1.97 | 0.04 | 36 | 70 | 79 | 156 |
| IE4 | FPU | SPU2 | 1.51 | 0.13 | 4 | 5 | 12 | 18 |
| IE5 | FPU | SPU3 | 1.48 | 0.18 | <1 | <1 | 6 | 8 |
| IE6 | FPU | SPU3 | 1.41 | 0.11 | 6 | 8 | 20 | 28 |
| IE7 | FPU | SPU3 | 0.99 | 0.13 | 4 | 4 | 34 | 34 |

As evident above, single layer structure made of (i) bromobutyl rubber based conventional materials (CE1 and CE2) and (ii) first PU material (CE3) result in very high N₂ and O₂ transmission rate and permeation. Further, an increase in the sample thickness from CE1 (0.68 mm) to CE2 (0.74 mm), only resulted in an increase in both N₂ and O₂ transmission rate and permeation values. On the contrary, the multilayer-structure of the inventive examples result in substantial reduction in the both N₂ and O₂ transmission rate and permeation values. In fact, the inventive sample IE5 had more than 98% reduction in N₂ transmission rate and more than 60% reduction in O₂ transmission rate when compared with conventional bromobutyl rubber (CE1 and CE2).

Tensile Properties

Both inventive and comparative samples were prepared for determining tensile properties in accordance with ASTM D412-16. For comparative samples, bromo butyl rubber (BNR) having high tensile modulus windings attached to it was used. The winding used for BNR was made of continuous filaments of polyamide 6 and/or polyester terephthalate (PET).

TABLE 3
Tensile properties of inventive and comparative samples

| | | | Total | 2^{nd} | Peak | | |
|---|---|---|---|---|---|---|---|
| | | | sample | layer | tensile | Tensile | |
| | First | Second | thickness | thickness | stress | modulus | Elongation |
| Example | layer | layer | (mm) | (mm) | (MPa) | (MPa) | (%) |
| CE3 | BNR | nil | 0.68 | nil | 4.2 | 4.8 | 237 |
| CE4 | BNR + | nil | 0.68 | nil | 7.9 | 64 | 164 |
| | winding | | | | | | |
| CE5 | FPU | nil | 1.28 | nil | 4.2 | 6.8 | 190 |
| IE3 | FPU | SPU2 | 1.97 | 0.04 | 2.9 | 12 | 108 |
| IE4 | FPU | SPU2 | 1.51 | 0.13 | 5.0 | 84 | 57 |

As evident above, the tensile properties obtained using the conventional material can be easily achieved by the present invention multilayer structure. Particularly, the tensile modulus which is an indicator of how well the structure will maintain dimensional stability while pressurized internally, is higher in the inventive examples. Thus, the multilayer structure in accordance with the present invention can be advantageously used for making a pressurized bladder for use in sports ball.

1. A multilayer structure comprising
(A) a first layer made of a first polyurethane material having a Shore A hardness of less than 80 determined according to ASTM D 2240 and obtained by reacting a first isocyanate component with a first polyol component, said first polyol component comprising a first polyether polyol having a nominal functionality of at least 2.0 and OH value ranging between 20 mg KOH/g to 100 mg KOH/g, and
(B) a second layer made of a second polyurethane material having a Shore D hardness of at least 40 determined according to ASTM D 2240 and obtained by reacting a second isocyanate component with a second polyol component, said second polyol component comprising at least one polyol having a nominal functionality of at least 2.0 and OH value ranging between 20 mg KOH/g to 1000 mg KOH/g.

2. The multilayer structure according to claim 1, wherein the first polyether polyol has a nominal functionality in between 2.0 to 4.0 and a OH value ranging between 20 mg KOH/g to 50 mg KOH/g.

3. The multilayer structure according to claim 1, wherein the polyol is selected from the group consisting of
(i) a polyether polyol having a nominal functionality ranging between 2.0 to 3.5 and OH value ranging between 20 mg KOH/g to 100 mg KOH/g,
(ii) a polyether polyol having a nominal functionality ranging between 2.5 to 5.0 and OH value ranging between 300 mg KOH/g to 1000 mg KOH/g, and
(iii) a polymer polyol having a nominal functionality ranging between 2.0 to 8.0 and OH value ranging between 20 mg KOH/g to 1000 mg KOH/g.

4. The multilayer structure according to claim 3, wherein the polyether polyol (i) is present in an amount in between 20 wt. % to 80 wt. %, based on the total weight of the second polyol component.

5. The multilayer structure according to claim 3, wherein the polyether polyol (ii) is present in an amount in between 20 wt. % to 60 wt. %, based on the total weight of the second polyol component.

6. The multilayer structure according to claim 3, wherein the polymer polyol (iii) is present in an amount in between 20 wt. % to 50 wt. %, based on the total weight of the second polyol component.

7. The multilayer structure according to claim 1, wherein the first isocyanate component and the second isocyanate component, independent of each other, comprises 2,2′-methylene diphenyl diisocyanate, 2,4′-methylene diphenyl diisocyanate, 4,4′-methylene diphenyl diisocyanate, mixtures thereof, or prepolymers obtained therefrom.

8. The multilayer structure according to claim 1, wherein the first isocyanate component and the second isocyanate component, independent of each other, further comprise di-isononyl-cyclohexane-1,2-dicarboxylate.

9. The multilayer structure according to claim 1, wherein the first polyol component and the second polyol component, independent of each other, further comprise at least one of chain extenders, plasticizers, catalysts, antifoams or molecular sieves.

10. A method of using the multilayer structure according to claim 1, the method comprising using the multilayer structure for a pressurized bladder.

11. A pressurized bladder comprising the multilayer structure according to claim 1, said bladder having a nitrogen gas transmission rate of less than 70 cm³m⁻²day⁻¹bar¹.

12. A process for preparing a pressurized bladder according to claim 11, said process comprising
(BL1) molding the first polyurethane material in a mold to obtain the first layer,
(BL2) injecting the second polyurethane material in the mold of step (BL1) to encapsulate the first layer, at least partially with the second layer, and
(BL3) shaping the first layer and the second layer of step (BL2) in the mold to obtain the pressurized bladder.

13. The process according to claim 12, wherein the molding is selected from the group consisting of injection molding, rotational molding, and slush molding.

14. A sports ball comprising a bladder for enclosing a pressurized fluid, the bladder including a first layer and a second layer,
wherein, the first layer is made of a first polyurethane material having a Shore A hardness of less than 80 determined according to ASTM D 2240 and obtained by reacting a first isocyanate component with a first polyol component, said first polyol component having a nominal functionality of at least 2.0 and OH value ranging between 20 mg KOH/g to 100 mg KOH/g, and
the second layer is made of a second polyurethane material having a Shore D hardness of at least 40 determined according to ASTM D 2240 and obtained by reacting a second isocyanate component with a second polyol component, said second polyol component having a nominal functionality of at least 2.0 and OH value ranging between 20 mg KOH/g to 1000 mg KOH/g.

15. The sports ball according to claim 14, wherein a thickness of the second layer is in between 1% to 30% of a thickness of the first layer, said thickness of the first layer ranging between 0.5 mm to 8.0 mm.
